(19) United States
(12) Patent Application Publication
(10) Pub. No.: US 2017/0253239 A1
(43) Pub. Date: Sep. 7, 2017

(54) DEVICE TO DETECT COUNTRY IN WHICH VEHICLE IS LOCATED

(71) Applicant: DENSO CORPORATION, Kariya-city (JP)

(72) Inventor: Shota Satomura, Kariya-city (JP)

(21) Appl. No.: 15/446,845

(22) Filed: Mar. 1, 2017

(30) Foreign Application Priority Data
Mar. 4, 2016 (JP) 2016-042087

(51) Int. Cl. B60W 30/14; G06K 9/62; G06K 9/00

(52) U.S. Cl. CPC B60W 30/146; G06K 9/00818; G06K 9/6201; B60W 2550/22

(57) ABSTRACT

In a device to detect a drive country in which a subject vehicle is located, a control section acquires correspondence information which shows a relationship between traffic signs and a degree of installation reliability of a traffic sign in each country as a drive country candidate in which the subject vehicle is located. The degree of installation reliability of each traffic sign indicates a degree of installation reliability located in each country. The control section acquires matching information which represents whether a traffic sign located around the subject vehicle matches the traffic sign stored in the correspondence information. The control section reads the degree of installation reliability of the traffic sign indicated by the matching information in each country stored in the correspondence information, and estimates, as the drive country in which the subject vehicle is driving, the country having a maximum degree of installation reliability of the traffic sign read from the correspondence information.

### CROSS-REFERENCE TO RELATED APPLICATION

This application is related to and claims priority from Japanese Patent Application No. 2016-42087 filed on Mar. 4, 2016, the contents of which are hereby incorporated by reference.

### BACKGROUND OF THE INVENTION

1. Field of the Invention

The present invention relates to devices, to be mounted on vehicles, which is capable of detecting a drive country in which a subject vehicle is now driving, i.e. located on the basis of detection results of traffic sign installed on a roadway or expressway in the drive country.

2. Description of the Related Art

There has been known a conventional technique capable of detecting road signs extracted from images captured by in-vehicle cameras or an image sensor mounted on a vehicle, and specifying traffic information so as to correctly execute a cruse assist of the vehicle on the basis of the detected traffic information such as traffic signs.

For example, a patent document 1, Japanese patent laid open publication No. JP 2015-146119 has disclosed a technique capable of specifying traffic information, for example, drive lane information indicating drive lanes and numerical information representing route numbers and speed limits on roadways on which a subject vehicle is driving on the basis of detected traffic signs which have been extracted from images captured by an in-vehicle camera or an image sensor mounted on the subject vehicle.

However, the conventional technique disclosed in the patent document 1 cannot estimate a drive country in which the subject vehicle is driving, i.e. located on the basis of the detected traffic signs. It is accordingly difficult for the conventional technique disclosed in the patent document 1 to correctly specify traffic information such as a lane width of a drive lane on a roadway, a speed limit on an expressway, etc. which have been defined in difference from each country.

### SUMMARY

It is therefore desired to provide a device, to be mounted on a vehicle, capable of detecting, estimating and specifying a drive country in which a subject vehicle is driving, i.e. located.

An exemplary embodiment provides a device to detect a drive country in which a subject vehicle is driving, i.e. located. The device has a computer system including a central processing unit. The computer system provides a correspondence information acquiring section, a matching information acquiring section, and a drive country estimation section. The correspondence information acquiring section acquires correspondence information. The correspondence information represents a relationship between traffic signs and a degree of installation reliability of each of the traffic signs in each of countries. Each of the countries is a drive country candidate in which a subject vehicle is driving, i.e. located. The degree of installation reliability of each of the traffic signs in each of the countries is expressed by a numeric value.

The matching information acquiring section acquires matching information. The matching information represents whether a traffic sign located around the subject vehicle matches the traffic sign stored in the correspondence information. The drive country estimation section reads the degree of installation reliability of the traffic sign, which is indicated by the matching information, in each of the countries stored in the correspondence information. The drive country estimation section estimates, as a drive country where the subject vehicle is driving, the country having a maximum degree of installation reliability of the traffic sign read from the correspondence information.

The device to detect the drive country in which the subject vehicle is driving, i.e. located according to the present invention uses represents a degree of installation reliability of the detected traffic sign, which is located in a country, expressed by a numeric value on the basis of the detection result of the traffic sign, and estimates the country having the maximum numeric value as the drive country in which the subject vehicle is driving.

This structure of the device to detect the drive country in which the subject vehicle is located makes it possible to correctly estimate the drive country in which the subject vehicle is driving on the basis of the traffic signs located and present around the subject vehicles.

### BRIEF DESCRIPTION OF THE DRAWINGS

A preferred, non-limiting embodiment of the present invention will be described by way of example with reference to the accompanying drawings, in which:

FIG. 1 is a block diagram showing a structure of a cruise assist system and a device to detect a drive country in which a subject vehicle is driving, i.e. located according to a first exemplary embodiment of the present invention;

FIG. 2 is a view showing a relationship between traffic signs and corresponding drive countries which use these traffic signs, and to be used by the device to detect the drive country according to the first exemplary embodiment of the present invention;

FIG. 3 is a view showing a flow chart of a drive country estimation process executed by the device to detect the drive country according to the first exemplary embodiment of the present invention; and

FIG. 4 is a view showing a flow chart of a country cruise assist process executed by the device to detect the drive country according to the first exemplary embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

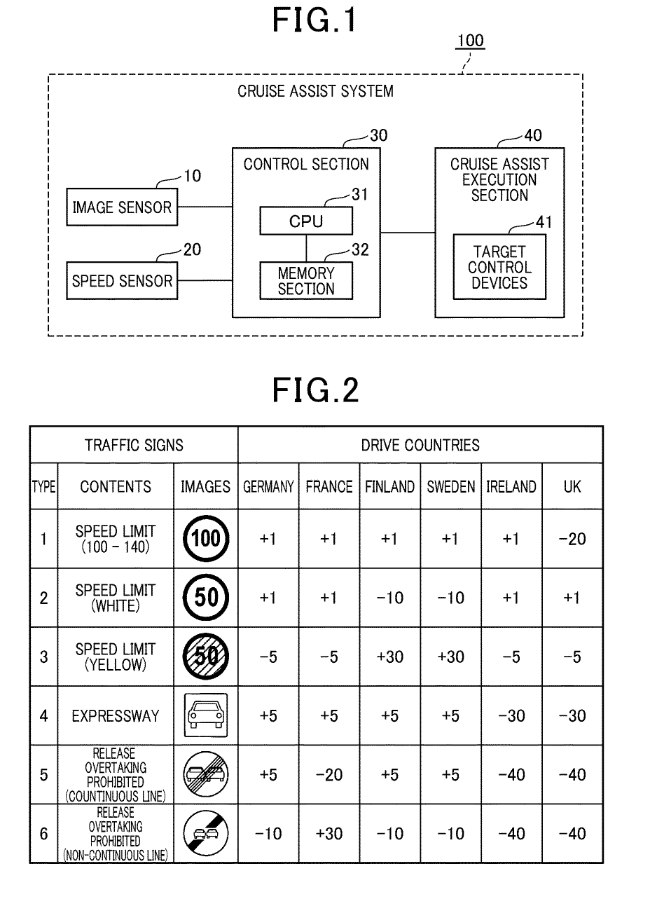

A description will be given of a cruise assist system and a device to detect a drive country in which a subject vehicle is driving, i.e. located according to a first exemplary embodiment with reference to FIG. 1 to FIG. 4.

FIG. 1 is a block diagram showing a structure of the cruise assist system 100 and a control section 30 as the device to detect the drive country according to the first exemplary embodiment. The cruise assist system 100 is applied to various types of motor vehicles.

As shown in FIG. 1, the cruise assist system 100 is equipped with an image sensor 10, a speed sensor 20, the control section 30 as the device to detect the drive country and a cruise assist execution section 40. The cruise assist system 100 is mounted on the subject vehicle.

The image sensor 10 acquires images around the subject vehicle, generates image signals and transmits the generated image signals to the control section 30 as the device to detect the drive country. The image sensor 10 acquires at least front image of the subject vehicle. The image sensor 10 has a CCD (charge coupled device) camera and is installed on a place near a rearview mirror in a compartment of the subject vehicle, for example. In the first exemplary embodiment, the image sensor 10 includes a CCD camera capable of at least detecting and recognizing yellow. However, the subject matter of the present invention is not limited by this. It is also acceptable to use a monochrome camera as the CCD camera.

The speed sensor 30 detects a speed of the subject vehicle, generates a speed signal, and transmits the generated speed signal to the control section 30 as the device to detect the drive country according to the first exemplary embodiment. The control section 30 as the device to detect the drive country is composed of a computer system. The computer system has a microcomputer which is known and available on the commercial market. The microcomputer is composed of a central processing unit (CPU) 31, a memory section 32, etc. The memory section 32 has semiconductor memories such as a read only memory (ROM), a random access memory (RAM), and a flash memory, etc. The semiconductor memories are non-transitory computer readable storage mediums.

The control section 30 as the device to detect the drive country executes at least a country cruise assist process and a drive country estimation process which will be explained later. The control section 30 obtains drive country information on the basis of the execution results of the country cruise assist process and the drive country estimation process. The control section 30 as the device to detect the drive country transmits the obtained drive country information to the cruise assist execution section 40.

The drive country information represents the estimated country information obtained by the execution of the drive country estimation process.

The drive country indicates the country in which the subject vehicle is now driving. As will be explained, in the drive country, traffic signs are detected on the basis of the images acquired by the image sensor 10 mounted on the subject vehicle.

The countries used by the device to detect the drive country according to the first exemplary embodiment contain political countries and countries using the common traffic signs. The control section 30 as the device to detect the drive country detects and recognizes traffic signs around the subject vehicle in the images acquired by the image sensor 10. The traffic signs represents traffic information such as limit information, permission information, guide, etc. so as to provide safety driving of vehicles. FIG. 2 is a view showing a relationship between traffic signs and corresponding countries using the traffic signs. Those traffic signs are detected and recognized by the control section 30 as the device to detect the drive country according to the first exemplary embodiment of the present invention.

When detecting and recognizing one or more traffic signs in the images acquired by the image sensor 10, the control section 30 as the device to detect the drive country generates recognition information regarding the detected and recognized traffic sign, and stores the generated recognition information into the memory section 32. The recognition information contains a shape, size and color of a feature part of the recognized traffic sign, which are distinguished from those in another traffic sign.

The control section 30 monitors a drive distance of the subject vehicle on the basis of the output signals transmitted from the speed sensor 20. The control section 30 stores drive distance information into the memory section 32 at every timing when the subject vehicle has moved by a predetermined update distance. The predetermined update distance has been determined in advance. The drive distance information represents that the drive distance of the subject vehicle reached the predetermined drive distance.

Correspondence information has been stored in the memory section 32. The drive country estimation process will use the correspondence information stored in the memory section. The correspondence information will be explained later.

Further, the control section 30 generates, and outputs matching information to the cruise assist execution section 40. The matching information indicates that the detected traffic sign is matched with a traffic sign in the correspondence information which has been stored in the memory section 32.

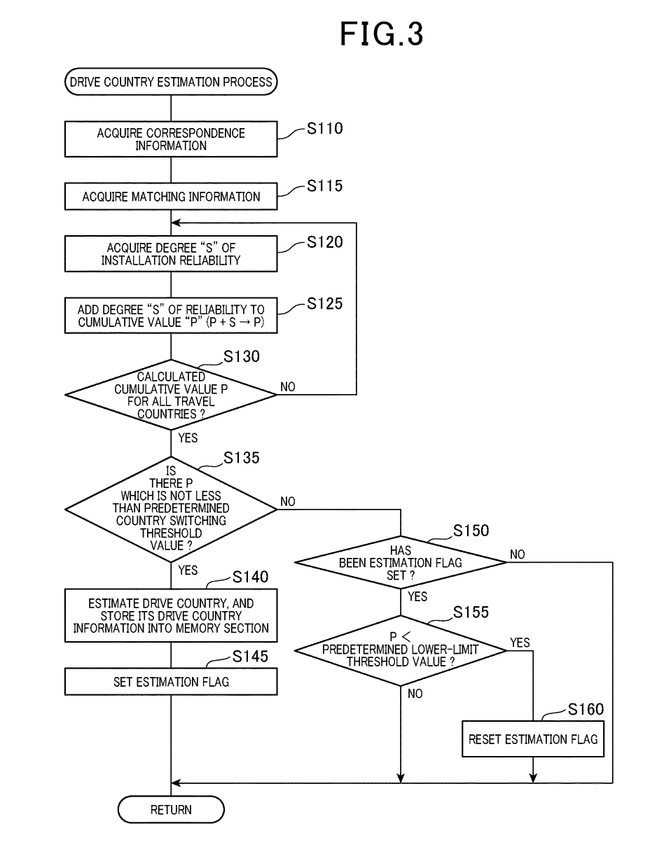

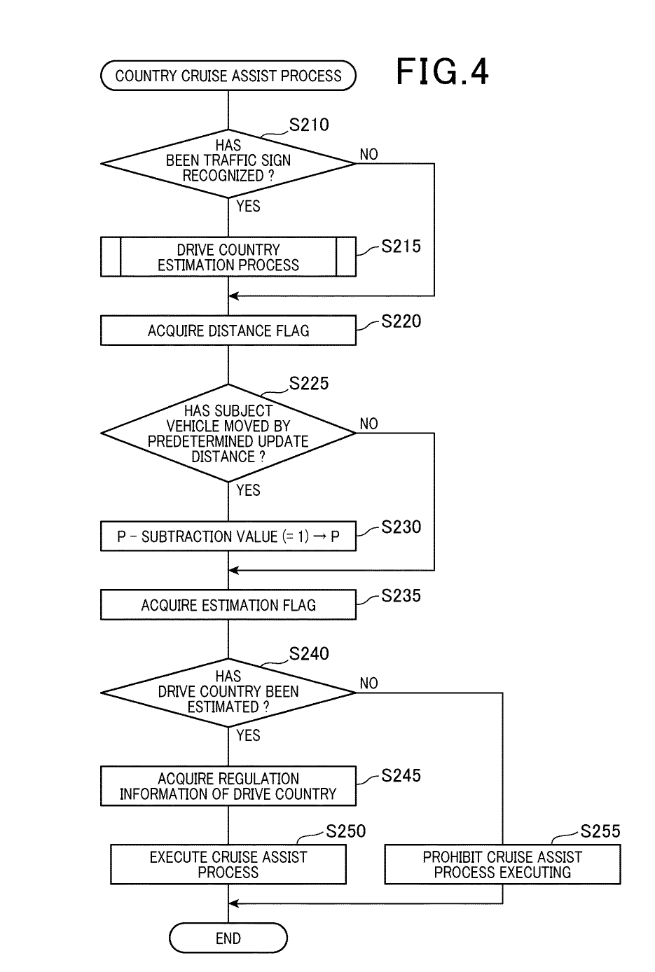

Various functions of the control section 30 can be realized by using programs stored in the ROM, etc. in the memory section 32. As previously explained, the ROM, RAM, etc. in the microcomputer system, which form the control section 30 as the device to detect the drive country according to the first exemplary embodiment, are semiconductor memories, i.e. a non-transitory computer readable storage medium. That is, the ROM in the memory section 32 is a non-transitory computer readable storage medium. The control section 30 reads the programs stored in the ROM in the memory section 32, and the CPU 31 execute the programs so as to execute the drive country estimation process shown in FIG. 3 and the country cruise assist process shown in FIG. 4.

It is acceptable to use one or more microcomputers to form the control section 30. It is also acceptable to use logical circuits, analogue circuits, a hardware device composed of a combination of these logical circuits and the analogue circuits so as to realize at least a part of the functions of the control section 30.

Similar to the control section 30 previously described, the cruise assist execution section 40 is also composed of a computer system. The computer system has a microcomputer which is known and available on the commercial market.

The cruise assist execution section 40 controls the operation of control target devices 41 on the basis of the drive country information transmitted from the control section 30. That is, the cruise assist execution section 40 adjusts the operation of each of the control target devices 41 on the basis of the drive country information, and executes necessary programs so as to execute the cruise assist which corresponds to the drive country in which the subject vehicle is not driving.

For example, there are a display device, speakers, etc. as the control target devices 41. The cruise assist execution section 40 instructs the display device as the control target device 41 to display various image information including warning information.

Further, the cruise assist execution section 40 instructs the speakers to provide warning sounds, and voice guidance to the driver of the subject vehicle.

### (Correspondence Information)

A description will now be given of the correspondence information which have been stored in the memory section 32.

The correspondence information represents a correspondence relationship between traffic signs and its degree of installation reliability in each country, i.e. each of drive country candidates. The subject vehicle can drive in the drive country candidates. The correspondence information has a table structure and stored in the memory section 32.

The degree of installation reliability in the correspondence information represents a likelihood of presence (or existence) of a traffic sign in drive countries. The degree of installation reliability of a traffic sign in each drive country is designated by using a numeric value.

The first exemplary embodiment determines the degree of installation reliability of each traffic sign on the basis of the following conditions (1) to (3).

### Condition (1)

When a traffic sign is used only by a specific country in the drive country candidates, this traffic sign has a large positive value of the degree of installation reliability. That is, a positive value of the degree of installation reliability represents the likelihood of the traffic sign to be installed in the drive country. The more the positive degree of installation reliability increases, the more the likelihood of presence of the traffic sign in the drive country increases.

### Condition (2)

On the other hand, when a traffic sign is not used in a specific country in the drive country candidates, this traffic sign has a large negative value of the degree of installation reliability. That is, the negative degree of installation reliability represents a likelihood of non-presence of the traffic sign in the drive country.

The more the degree of installation reliability being small, in other words, the more an absolute value of the negative degree of installation reliability increases, the more the likelihood of non-presence of the traffic sign in the drive country increases.

### Condition (3)

The degree of installation reliability of a traffic sign having a high frequency of appearance in the drive county has a small absolute value when compared with a traffic sign having a low frequency of appearance in the drive country. The frequency of appearance represents the frequency of installation of the traffic sign in the drive country.

In the following explanation, a traffic sign interval represents an interval of installation location of the traffic signs. The minimum traffic sign interval indicates an experimental interval of traffic signs.

The first exemplary embodiment uses the traffic sign interval of 1 km. It is also acceptable for each of the countries to have a different minimum traffic sign interval.

Traffic signs, which have a large frequency of appearance, for example, located at every 1 km interval along a roadway, have an absolute value of the degree of installation reliability thereof that is smaller than a degree of installation reliability of a traffic sign located at every 5 km interval.

Specifically, the control section 30 as the device to detect the drive country according to the first exemplary embodiment uses the correspondence information shown in FIG. 2.

FIG. 2 shows six country candidates, i.e. Germany, France, Finland, Sweden, Ireland, and the UK in which the subject vehicle is driving, i.e. located. FIG. 2 shows the traffic signs 1 to 6 which have been prepared. In FIG. 2, the traffic signs 1 to 3 represent speed limit signs.

The traffic sign 1 represents a speed limit of 100 and is located every 1 km interval. There are two types of countries in Europe, some use the Kilometer unit system, and the others uses the Mile unit system. For example, the UK uses the Mile unit system, and Germany, France, Finland, Sweden and Ireland use the Kilometer unit system. For example, the UK does not use the traffic sign 1 which represents the speed limit of 100 because the UK uses the Mile unit system, and this exceeds the maximum legal speed for vehicles. On the other hand, the other drive countries shown in FIG. 2, excepting the UK, use the traffic sign 1 which represents the speed limit of 100 because of using the Kilometer unit system.

Accordingly, as shown in FIG. 2, in the UK, the traffic sign 1 has the degree of installation reliability of −20. Further, it is difficult to specify one of the countries other than the UK on the basis of the traffic sign 1. Because the frequency of appearance of the traffic sign 1 is large, the traffic sign 1 has the degree of installation reliability of +1 in the other drive countries, i.e. Germany, France, Finland, Sweden and Ireland, excepting the UK.

Each of the traffic signs 2 and 3 represents the speed limit of 50. The background color of the traffic sign 2 is white, and the background color of the traffic sign 3 is yellow. In general, because Finland and Sweden are snowy countries, i.e. have a lot of snow, the background of the traffic signs is yellow. In other drive countries excepting Finland and Sweden, the background of the traffic signs is white.

Accordingly, the traffic sign 2 has the degree of installation reliability of −10 in Finland and Sweden, and the traffic sign 2 has the degree of installation reliability of +1 in the other countries excepting Finland and Sweden.

Similarly, the traffic sign 3 has the degree of installation reliability of +30 in Finland and Sweden, and the traffic sign 3 has the degree of installation reliability of −5 in the other drive countries other than Finland and Sweden.

In Finland and Sweden, the traffic sign 2 has the degree of installation reliability of −10, not −30. This makes it possible to avoid incorrect detection of the traffic sign 2 in Finland and Sweden. That is, there is a possible incorrect detection in which the traffic sign 3 having the yellow background is regarded as the traffic sign 2 having the white background. Accordingly, in order to avoid the occurrence of the incorrect detection of the traffic sign 2 having the white background, the traffic sign 2 has the degree of installation reliability of −10, not −30 in Finland and Sweden.

The traffic sign 4 represents an expressway (or a freeway) which allows vehicles only to drive. For example, the traffic signs 4 are located at every 5 km interval along an expressway (or freeway). Because the UK and Ireland do not have this type of expressway sign, the traffic signs have the degree of installation reliability of −30 in the UK and Ireland. Because it is difficult to specify the other drive countries, other than the UK and Ireland, on the basis of the traffic sign 4, and the traffic sign 4 installed on an expressway has the frequency of appearance which is smaller than the frequency of appearance of the traffic sign 1, the traffic sign 4 has the degree of installation reliability of +5 in the other countries excepting the UK and Ireland.

The traffic signs 5 and 6 represent traffic signs which release overtaking which has been prohibited, i.e. allow vehicles to overtake. The traffic sign 5 uses continuous oblique lines. On the other hand, the traffic sign 6 uses dotted oblique lines.

Because the UK and Ireland have no traffic sign which release overtaking from being prohibited, the traffic signs 5 and 6 have the degree of installation reliability of −40 in the UK and Ireland.

Further, because the traffic sign 6 is installed in France only, the traffic sign 6 has the degree of installation reliability of +30 in France. In addition, the traffic sign 5 does not have the degree of installation reliability of −30 in France in order to avoid incorrect recognition of the oblique lines in the traffic sign 5 in France.

Because it is difficult to specify the drive countries, other than the UK, Ireland and France, on the basis of the traffic signs 5 and 6, the traffic sign 5 has the degree of installation reliability of +5 and the traffic sign 6 has the degree of installation reliability of −10 in the countries excepting the UK, Ireland and France in view of the frequency of appearance of these traffic signs 5 and 6 and to avoid incorrect recognition of the traffic signs 5 and 6.

FIG. 2 shows one example of the correspondence information. The concept of the present invention is not limited by the contents of the correspondence information shown in FIG. 2. For example, it is possible to change the number of the drive countries, the types of traffic signs and the number of traffic signs, and a value of the degree of installation reliability of these traffic signs. It is acceptable to add traffic information of drive countries, other than European countries, into the corresponding information.

### (Drive Country Estimation Process)

A description will now be given of the drive country estimation process with reference to FIG. 3.

FIG. 3 is a view showing a flow chart of the drive country estimation process executed by the control section 30 as the device to detect the drive country according to the first exemplary embodiment.

The drive country estimation process estimates the drive country, in which the subject vehicle is driving, i.e. located, on the basis of one or more detected traffic signs, which have been extracted from the images captured by the image sensor 10.

The control section 30 as the device to detect the drive country according to the first exemplary embodiment executes the drive country estimation process at every timing when the image sensor 10 recognizes a traffic sign in the images captured by the image sensor 10. The drive country estimation process corresponds to the process in step S215 in the country cruise assist process shown in FIG. 4. The country cruise assist process will be explained later.

In step S110 shown in FIG. 3, the CPU 31 acquires the correspondence information stored in memory section 31, for example shown in FIG. 2. The operation flow progresses to step S115.

In step S115, the CPU 31 obtains the matching information. The matching information indicates that the detected traffic sign is matched with a traffic sign stored in the correspondence information shown in FIG. 2. The CPU 31 repeatedly executes the process in step S115 at every timing when the traffic sign is detected and the country cruise assist process shown in FIG. 4 is executed.

When the CPU 31 detects that the traffic sign detected in the images captured by the image sensor 10 is located around the subject vehicle and represents a speed limit of 100, the CPU 31 obtains the matching information in which the detected traffic sign is the traffic sign 1 contained in the correspondence information stored in FIG. 2. The operation flow progresses to step S120.

In step S120, the CPU 31 reads the degree S of installation reliability of the traffic sign which is indicated by the correspondence information of a drive country (as a calculation target country) in the drive countries as the drive country candidates in which the subject vehicle is driving, i.e. lcoated. For example, when the calculation target country is Germany, and the matching information indicates that the traffic sign located around the subject vehicle is the traffic sign 1, the degree S of installation reliability of the traffic sign 1 is +1. The operation flow progresses to step S125.

In step S125, the CPU 31 adds the degree S of installation reliability of the traffic sign in the calculation target country obtained in step S120 to a cumulative value P of the calculation target country, and stores the added cumulative value of the calculation target country into the memory section 32.

The degree S of installation reliability of the traffic sign indicated by the matching information is read from the correspondence information, and added to the cumulative value P of the calculation target country at every timing when the traffic sign is detected and the matching information is obtained.

For example, when the calculation target country is Germany, the degree S of installation reliability +1, which is the degree of installation reliability of the traffic sign 1, is added to the cumulative value P of Germany, and the calculated cumulative value P of Germany is stored in the memory section 32.

In the first exemplary embodiment, the cumulative value P of the calculation target country has an initial value of zero (P=0) when the ignition switch (not shown) of the subject vehicle is turned on, i.e. the engine of the subject vehicle starts and the operation of the country assist process is started. The operation flow progresses to step S130.

In step S130, the CPU 31 detects whether the processes in step S120 to step S125 for all of the drive countries in the correspondence information have been finished.

When the detection result indicates negation (“NO” in step S130), i.e. one or more countries still remain, the operation flow returns to step S120.

On the other hand, when the detection result indicates affirmation (“YES” in step S130), i.e. no drive country remains, the operation flow progresses to step S135.

As previously described, the CPU 31 reads the degree S of installation reliability of the traffic sign indicated by the matching information, and calculates the cumulative value P every drive countries, and stores the calculated cumulative value P of the calculation target country into the memory section 32.

In step S135, the CPU 31 detects for every drive country whether the cumulative value P of each calculation target country stored in the memory section 32 is not more than a predetermined country switching threshold value which has been determined in advance.

When the detection result indicates affirmation (“YES” in step S135), i.e. there is the cumulative value P of the calculation target country which is not less than the predetermined country switching threshold value, the operation flow progresses to step S140.

On the other hand, when the detection result indicates negation (“NO” in step S135), i.e. there is no cumulative value P of not less than the predetermined country switching threshold value, the operation flow progresses to step S150.

The predetermined country switching threshold value has been determined for each calculation target country in advance, according to an accuracy which represents the degree of installation reliability of the estimated drive country. The first exemplary embodiment uses the predetermined country switching threshold value of 100. The concept of the present invention is not limited by this predetermined country switching threshold value of 100. It is possible to use the predetermined country switching threshold value of more than 100.

It is acceptable to use the predetermined country switching threshold value of a small value in order to quickly switch the estimation result of the target drive country when the subject vehicle is driving on a roadway near a border between countries. The predetermined country switching threshold value has been stored in the memory section 32. The operation flow progresses to step S140.

In step S140, the CPU 31 in the control section 30 as the device to detect the drive country according to the first exemplary embodiment estimates, as the drive country in which the subject vehicle is driving, the country which corresponds to the cumulative value P of not less than the predetermined country switching threshold value. The CPU 31 stores the estimation result as the drive country information into the memory section 312.

That is, the CPU 31 estimates, as the drive country in which the subject vehicle is now driving, the country having the maximum cumulative value P of not less than the predetermined country switching threshold value. The drive country information represents the estimated drive country. The operation flow progresses to step S145.

In step S145, the CPU 31 sets an estimation flag to a predetermined value, for example a value of 1. This estimation flag of 1 represents that the drive country has been estimated. The CPU 31 finishes the drive country estimation process shown in FIG. 3.

In step S150, the CPU 31 detects whether the drive country has been estimated. Specifically, the CPU 31 determines that the drive country has been estimated immediately before when the estimation flag has been set. That is, when the detection result indicates affirmation (“YES” in step S150), i.e. the estimation flag has already been set immediately before the process in step S150, the operation flow progresses to step S155. The operation flow progresses to step S155.

On the other hand, when the detection result indicates negation (“NO” in step S150), i.e. no estimation flag has been set, the operation flow progresses to step S155. The CPU 31 finishes the drive country estimation process shown in FIG. 3.

In step S155, the CPU 31 detects whether or not the cumulative value P is less than a predetermined lower-limit threshold value. The predetermined lower-limit threshold value represents the lower limit value of the cumulative value P which is necessary to correctly estimate the drive country in which the subject vehicle is driving. The first exemplary embodiment uses the predetermined lower-limit threshold value of 80. However, the concept of the present invention is not limited by this predetermined lower-limit threshold value of 80.

When the detection result indicates affirmation (“YES” in step S155), i.e. the cumulative value P is less than the predetermined lower-limit threshold value, the operation flow progresses to step S160.

In step S160, the CPU 31 resets the estimation flag, and finishes the drive country estimation process shown in FIG. 3.

On the other hand, when the detection result indicates negation (“NO” in step S155), i.e. the cumulative value P is not less than the predetermined lower-limit threshold value, the CPU 31 finishes the drive country estimation process shown in FIG. 3.

### (Country Cruise Assist Process)

A description will be given of the country cruise assist process with reference to FIG. 4.

FIG. 4 is a view showing a flow chart of the country cruise assist process executed by the control section 30 as the device to detect the drive country according to the first exemplary embodiment of the present invention.

As shown in FIG. 4, the control section 30 executes the country cruise assist process on the basis of regulation information of each drive country and the estimated drive country obtained by the drive country estimation process shown in FIG. 3.

The CPU 31 repeatedly executes the country cruise assist process during the period in which the ignition switch (not shown) of the subject vehicle is turned on.

When the country cruise assist process shown in FIG. 4 is executed, the CPU 31 detects whether a traffic sign which is present, i.e. located around the subject vehicle is recognized. Specifically, when the detection result indicates affirmation (“YES” in step S210), i.e. the CPU 31 receives traffic sign recognition information and detects the traffic sign, the CPU 31 determines that the traffic sign has been recognized. The operation flow progresses to step S220. The operation flow progresses to step S215.

On the other hand, when the detection result indicates negation (“NO” in step S210), i.e. the CPU 31 does not recognize a traffic sign around the subject vehicle, the operation flow progresses to step S220.

In step S215, the CPU 31 executes the drive country estimation process shown in FIG. 3 which has been explained in detail.

In the drive country estimation process shown in FIG. 3, when the drive country is estimated, the CPU 31 stores an estimation graph, the drive country information and the cumulative value P into the memory section 32. The estimation graph shows that the drive country has been estimated. The drive country information represents the drive country in which the subject vehicle is driving. The operation flow progresses to step S220.

In step S220, the CPU 31 reads and acquires the drive distance information which have been stored in the memory section 32. The drive information indicates the drive distance of the subject vehicle. The CPU 31 in the control section 30 as the device to detect the drive country according to the first exemplary embodiment stores the drive distance information into the memory section 32 at every timing when the subject vehicle has moved by the predetermined update distance which has been determined in advance.

The first exemplary embodiment uses the predetermined update distance of 1 km as the minimum traffic sign interval. However, the concept of the present invention is not limited by this minimum traffic sign interval of 1 km.

The predetermined update distance as the minimum traffic sign interval increases according to increasing of a predetermined subtraction value. The predetermined subtraction value will be explained. Further, the predetermined update distance as the minimum traffic sign interval reduces according to reduction of the predetermined subtraction value. It is also possible to use an optional value as the predetermined update distance.

The control section 30 as the device to detect the drive country according to the first exemplary embodiment uses, as drive distance information, a distance flag which is set at every timing when the subject vehicle has moved by 1 km. The distance of 1 km is the predetermined update distance. The operation flow progresses to step S225.

In step S225, the CPU 31 detects whether the subject vehicle has moved by the predetermined update distance of 1 km.

The CPU 31 detects that the subject vehicle has moved by the predetermined update distance when the distance flag obtained in step S220 has been set, for example, the distance flag has a value of 1.

When the detection result indicates affirmation (“YES” in step S225), i.e. the subject vehicle has moved by the predetermined update distance of 1 km, the operation flow progresses to step S220. The operation flow progresses to step S230.

On the other hand, when the detection result indicates negation (“NO” in step S225), i.e. the subject vehicle does not move by the predetermined update distance of 1 km, the operation flow progresses to step S220. The operation flow progresses to step S235.

In step S230, the CPU 31 subtracts the predetermined subtraction value from the cumulative value P stored in the memory section 32, and stores the subtraction result as the cumulative value P into the memory section 32. The CPU 31 resets the distance flag, and the operation flow progresses to step S235.

The CPU 31 obtains the drive distance information at every timing when the subject vehicle moves by the predetermined update distance. That is, the CPU 31 stores the cumulative value P, from which the predetermined subtraction value has been subtracted, at every timing when the subject vehicle moves by the predetermined update distance regardless of the recognition of the traffic sign in the images captured by the image sensor 10.

The predetermined subtraction value has been stored in the memory section 32. The predetermined subtraction value is 1 every predetermined update distance of 1 km. However, the concept of the present invention is not limited by the predetermined subtraction value of 1. It is acceptable to increase the predetermined subtraction value according to increase of the predetermined update distance, or decrease the predetermined subtraction value according to reduction of the predetermined update distance. Similarly, it is possible to reduce the predetermined subtraction value according to reduction of the predetermined update distance. For example, when the predetermined update distance is 0.1 km, the predetermined subtraction value becomes 0.1.

Because the predetermined subtraction value is subtracted from the cumulative value P at every timing when the drive distance increases by the predetermined update distance, this makes it possible to avoid influence of a past degree S of installation reliability from applied to the current country estimation. That is, this makes it possible to estimate the drive country on the basis of the degree S of installation reliability of a traffic sign which has been detected immediately before. The predetermined subtraction value has been set so as to suppress the past degree S of installation reliability of a traffic sign which was detected from being influenced to the estimation of the current drive country.

In particular, the correspondence between the predetermined update distance, the predetermined subtraction value, and the traffic sign installed at every minimum traffic sign interval has been set and stored in the memory section 32.

A description will now be given of the correspondence between the predetermined update distance, the predetermined subtraction value, and the traffic sign.

In non-specific drive countries, for example, Germany, France, Sweden, Ireland, it is difficult to detect the specific countries from the sign, for example, the traffic sign 1 shown in FIG. 2 which is located at every minimum traffic sign interval.

Each of the non-specific countries has a non-specific country degree of installation reliability. For example, the non-specific country has the non-specific country degree of installation reliability of +1, as shown in FIG. 2.

In the first exemplary embodiment, the minimum traffic sign interval is used as the predetermined update distance, and the non-specific country degree of installation reliability is used as the predetermined subtraction value.

For example, if the subject vehicle is driving, i.e. located on a roadway in France, it is difficult to correctly specify the drive country when the traffic signs 1 is detected at every minimum traffic sign interval of 1 km because the traffic sign 1 is located at the same frequency of appearance in the non-specific countries such as Germany, Finland, Sweden and Ireland.

When the CPU 31 repeatedly detects the traffic sign 1, there is a possible problem in which the cumulative value P of the non-specific countries becomes not less than the predetermined country switching threshold value. That is, it is preferable to provide no influence of the degree S of installation reliability to the cumulative value P even if the CPU 31 detects the presence of the traffic sign 1 with which it is difficult to determine the specific country.

In the first exemplary embodiment, the CPU 31 subtracts the non-specific country degree of installation reliability having a value of +1 from the cumulative value P at every timing when the subject vehicle moves by the minimum traffic sign interval of 1 km, and stores the calculated cumulative value P into the memory section 32. This makes it possible to avoid the influence caused by the detection of the traffic sign 1 from being applied to the cumulative value P even if the CPU 31 detects the traffic sign 1 at every timing when the subject vehicle drives by the minimum traffic sign interval. The operation flow progresses to step S235.

In step S235, the CPU 31 acquires the estimation flag. The operation flow progresses to step S240.

In step S240, the CPU 31 detects whether the drive country has been estimated by the drive country estimation process. Specifically, when the estimation flag obtained in step S235 has been set in the memory section 32, the CPU 31 detects that the drive country has been estimated by the drive country estimation process.

When the detection result indicates affirmation (“YES” in step S240), i.e. the drive country has been estimated by the drive country estimation process, the operation flow progresses to step S245.

On the other hand, when the detection result indicates negation (“NO” in step S240), i.e. no drive country has been estimated by the drive country estimation process, the operation flow progresses to step S255.

In step S250, the CPU 31 acquires the regulation information which corresponds to the drive country indicated by the drive country information stored in the memory section 32, where the drive country has been estimated by the execution of the drive country estimation process.

In the first exemplary embodiment, the regulation information for each of the drive country candidates has been stored in the memory section 32. The drive country candidates are candidates in which the subject vehicle is driving on a roadway therein.

The regulation information represents the regulation of the estimated drive country so as to provide safe driving of the subject vehicle in the estimated rive country. For example, there are, as the regulation information, an upper speed limit, a lane width, etc. The upper limit speed regulates the vehicle speed on roadways and expressways. The lane width is used to prevent vehicles from departing a drive lane.

The regulation information is not limited by this. It is acceptable to use any information decided by each country to provide safe driving of vehicles. The operation flow progresses to step S250.

In step S250, the CPU 31 executes the cruise assist which corresponds to each drive country in which the subject vehicle is driving. Specifically, the CPU 31 in the control section 30 as the device to detect the drive country instructs the cruise assist execution section 40 to execute the cruise assist. The CPU 31 finishes the execution of the country cruise assist process shown in FIG. 4.

The cruise assist is executed when the driver operates the subject vehicle. The cruise assist includes an assistance (hereinafter, a regulation cruise assist) to drive the subject vehicle within the regulation information. For example, it is acceptable for an assistance to provide warning (buzzer, sounds, warning message) to the driver of the subject vehicle through a speaker and/or a display device when a speed of the subject vehicle exceeds an upper limit speed, and/or the subject vehicle departs the vehicle lane on which the subject vehicle is driving.

On the other hand, in step S255, the CPU 31 finishes the country cruise assist process. Specifically, the CPU 31 instructs the cruise assist execution section 40 to stop the cruise assist executing. The CPU 31 finishes the country cruise assist process shown in FIG. 4.

The CPU 31 executes the country cruise assist process previously described. That is, the CPU 31 reads, from the correspondence information stored in the memory section 32, the degree S of installation reliability of the traffic signal in each drive country indicated by the matching information at every timing when the matching information of the detected traffic sign is obtained. The CPU 31 calculates the cumulative value P of each drive country, which is a sum of the cumulative value P the CPU 31 estimates, as the drive country, the country which has the maximum cumulative value P which is not less than the predetermined country switching threshold value. The CPU 31 executes the cruise assist which corresponds to the estimated drive country.

### Effects

The control section 30 as the device to detect the drive country according to the first exemplary embodiment has the following effects.

(3a) In step S110, the control section 30 acquires the correspondence information of each drive country which is the candidate of the drive country in which the subject vehicle is driving, i.e. located. The correspondence information represents the correspondence relationship between traffic signs and its degree of installation reliability installed in the drive country candidate. The degree of installation reliability of a traffic sign is designated by using a numeric value. In step S115, the control section 30 acquires the matching information which represents that the traffic sign stored in the correspondence information is the detected traffic sign located around the subject vehicle.

In step S140, the control section 30 reads the degree of installation reliability of the traffic sign indicated by the matching information of each drive country, and estimates the drive country having the maximum degree of installation reliability in which the subject vehicle is driving.

That is, the control section 30 uses a numeric value which expresses the degree of installation reliability of the detected traffic sign which has been installed in the drive country, and estimates the country having the maximum numeric value as the drive country in which the subject vehicle is driving.

This makes it possible for the control section 30 as the device to detect the drive country to estimate the drive country in which the subject vehicle is driving on the basis of the detected result of the traffic signs. Further, it is possible for the control section 30 to correctly estimate the drive country on the basis of the detection traffic sign in the images captured by the image sensor 10 without using map data.

(3b) In step S115, it is acceptable for the control section 3 to repeatedly acquire the matching information of the traffic sign. In step S140, the control section 30 reads, from the correspondence information, the degree of installation reliability of the traffic sign indicated by the matching information at every timing when the matching information is acquired. The control section 30 adds the degree of installation reliability of the traffic sign to the cumulative value P per each drive country. It is acceptable for the control section 30 to estimate that the country having the maximum cumulative value P is the drive country in which the subject vehicle is driving.

This makes it possible to increase the estimation accuracy of the drive country by using the detection results of the traffic signs.

(3c) In step S210, it is acceptable for the control section 30 to acquire the drive distance information at every timing when the subject vehicle moves by the predetermined update distance. The drive distance information represents that the subject vehicle has moved by the predetermined drive distance.

In step S230, it is acceptable for the control section 30 to subtract a predetermined value instead of using the predetermined subtraction value from the cumulative value P of each drive country when the drive distance information has been acquired.

This makes it possible to suppress the influence of the degree S of installation reliability of the past-detected traffic sign to the cumulative value P because the cumulative value P is reduced by the predetermined subtraction value at every timing when the subject vehicle moves by the predetermined drive distance even if no traffic sign is detected.

For example, this makes it possible to suppress incorrect recognition of the drive country on the basis of the past recognition result of the traffic signs when the subject vehicle has moved across the border between two countries. Further, it is possible to quickly estimate the drive country immediately after the subject vehicle has moved across the border.

(3d) In step S140, it is acceptable for the control section 30 to estimate, as the drive country, the country having the cumulative value P which is not less than the predetermined country switching threshold value. This makes it possible to more increase the estimation accuracy of the drive country when the predetermined country switching threshold value is increased. On the other hand, it is possible to speedily estimate the drive country after when the subject vehicle moves across the border when the predetermined country switching threshold value is reduced.
(3e) In step S245, it is acceptable for the control section 30 to acquire the regulation information of the estimated drive country to provide safe driving to vehicles. In step S250, it is possible for the control device 30 to execute the cruise assist of the subject vehicle within the regulation obtained in step S245. This makes it possible for the control section 30 to execute detailed cruise assist corresponding to the drive country.

In the first exemplary embodiment, the control section 30 corresponds to the device to detect the drive country. The control section 30 corresponds to each of the drive distance information acquiring section, the degree of installation reliability subtracting section, the regulation information acquiring section, the cruise assist section, the correspondence information acquiring section, the matching information acquiring section and the drive country estimation section.

The process in step S220 corresponds to the process executed by the drive distance information acquiring section. The process in step S230 corresponds to the process executed by the degree of installation reliability subtracting section. The process in step S245 corresponds to the process executed by the regulation information acquiring section. The process in step S250 corresponds to the process executed by the cruise assist section. The process in step S110 corresponds to the process executed by the correspondence information acquiring section. The process in step S115 corresponds to the process executed by the matching information acquiring section. The process in step S140 corresponds to the process executed by the drive country estimation section.

### Various Modifications

A description will be given of the control section 30 as the device to detect the drive country according to modifications. The concept of the present invention is not limited by the first exemplary embodiment previously described.

(4a) In the first exemplary embodiment previously described, the control section 30 repeatedly acquires the matching information of the traffic sign located around the subject vehicle, and calculates the cumulative value P of the traffic sign indicated by the matching information in each drive country candidate at every timing when the matching information is acquired. The control section 30 estimates, as the drive country, the country having the maximum cumulative value P which is not less than the predetermined country switching threshold value. However, the concept of the present invention is not limited by the first exemplary embodiment.

For example, it is acceptable for the control section 30 to read the degree S of installation reliability of the traffic sign indicated by the matching information at every timing of acquiring the matching information, and estimates as the drive country the country having the maximum degree S of installation reliability in the correspondence information.

For example, it is possible to set +100 to the installation reliability of the traffic sign 6 in France shown in FIGS. 2, to +100, and executes the drive country estimation process. In this case, it is acceptable to eliminate the processes in step S125, S135 and S150 to S160 in the drive country estimation process shown in FIG. 3. Further, the control section 30 detects whether each drive country has the degree S of installation reliability of the traffic sign 6, instead of the execution of the process in step S130. When the detection result indicates affirmation, it is acceptable for the control section 30 to estimate as the drive country the country having the maximum degree S of installation reliability of the traffic sign 6 in the correspondence information, instead of the execution of the process in step S140.

When the traffic sign 6 is detected, because it is not necessary to detect whether the cumulative value P becomes not less than the predetermined country switching threshold value, it is possible for the control section 30 to quickly select France as the drive country in which the subject vehicle is driving.

It is acceptable for the control section 30 to estimate as the drive country the country which corresponds to the maximum cumulative value P without comparing the cumulative value P with the predetermined country switching threshold value. In this case, it is acceptable to eliminate the processes in step S135, and S150 to S160 in the drive country estimation process shown in FIG. 3. Further, the control section 30 estimates, as the drive country, the country having the maximum cumulative value P, instead of the execution of the process in step S140.

(4b) In the first exemplary embodiment previously described, the control section 30 acquires the drive distance information at every timing when the subject vehicle moves by the predetermined update distance, and subtracts the predetermined subtraction value from the cumulative value P when acquiring the drive distance information. However, the concept of the present invention is not limited by this.

For example, it is acceptable to eliminate, from the control section 30, the structure of acquiring the drive distance information, and the structure of subtracting the predetermined subtraction value from the cumulative value P at a timing when receiving the drive distance information. This makes it possible to have the same effect (1a) previously described.

(4c) In the first exemplary embodiment previously described, the control section 30 acquires the regulation information which corresponds to the drive country stored in the memory section 32. However, the concept of the present invention is not limited by this. For example, when the cruise assist system 100 has a communication device, it is possible for the control section 30 to acquire necessary regulation information stored in databases through a network communication, or to receive the regulation information from other vehicles through a wireless network communication.

It is possible for the control section 30 to receive various information in addition to the regulation information. For example, it is possible for the control section 30 to acquire specific information of the estimated drive country, which contain map information, entertainment information, instead of the regulation information

Further, it is acceptable for the control section 30 to execute the cruise assist on the basis of the acquired specific information of the estimated drive country. Still further, it is acceptable for the control section 30 to have a structure which executes no cruise assist when the drive country has been estimated.

(4d) In the first exemplary embodiment previously described, the control section 30 prohibits the cruise assist executing in the drive country in step S255 when no drive country has been estimated in step S240. However, the concept of the present invention is not limited by this.

It is also acceptable for the control section 30 to execute the following cruise assist, instead of the execution of step S255, when the cumulative value P becomes less than the predetermined lower-limit threshold value, and it becomes difficult to correctly estimate the drive country after the drive country has been estimated once.

For example, instead of the execution in step S255, it is acceptable for the control section 30 to execute the cruise assist of the subject vehicle on the basis of the regulation information which is commonly used in the area in which the subject vehicle is driving. That is, when the subject vehicle is driving in Europe, it is possible for the control section 30 to execute the cruise assist on the basis of the regulation information commonly used in the counties in Europe.

It is acceptable for the control section 30 to execute the cruise assist of the subject vehicle, instead of executing the process in step S255, on the basis of most stringent regulation information in the countries in which the subject vehicle is driving, for example, on the basis of the minimum upper limit speed.

(4e) In the first exemplary embodiment previously described, the control section 30 uses the predetermined country switching threshold value which is the same value in the drive country candidates in which the subject vehicle drives. However, the concept of the present invention is not limited by this. For example, it is acceptable for each drive country candidate to use a different value of the predetermined country switching threshold value.

For example, when a drive country is oversee and far from the country of purchase where the subject vehicle has been purchased, it is acceptable for the drive country to have a large value as the predetermined country switching threshold value when compared with that of the countries to which the subject vehicle can reach easily from the country of purchase. Because there is a low probability in which the subject vehicle is driving in a country to which it is difficult for the subject vehicle to move, it is possible to suppress the incorrect detection from occurring by using a large value as the predetermined country switching threshold value.

(4f) In the first exemplary embodiment previously described, the control section 30 uses a value of 0 as the initial value of the cumulative value P. However, the concept of the present invention is not limited by this. For example, it is possible for the drive country near the country of purchase to use a large initial value as the cumulative value P.
(4g) It is acceptable for the control section 30 to estimate, as the drive country, the country to which the subject vehicle easily moves from the purchase country when detecting the multiple countries which have the maximum cumulative value P of not less than the predetermined country switching threshold value.
(4h) In the first exemplary embodiment previously described, the control section 30 uses the fixed value as the predetermined country switching threshold value. However, the concept of the present invention is not limited by this, and it is acceptable for the control section 30 to use a value within a range of 95 to 105 as the predetermined country switching threshold value, instead of using the fixed value of 100. This makes it possible to reduce the frequency of switching the estimated drive country when compared with using the fixed value, for example 100 of the predetermined country switching threshold value.
(4i) In the first exemplary embodiment previously described, the control section 30 executes the cruise assist on the basis of the regulation information. However, the concept of the present invention is not limited by this. It is acceptable for the cruise assist executed by the control section 30 to include the cruise assist so that the speed of the subject vehicle does not exceed the upper limit speed, the cruise assist which prevents the subject vehicle form departing from the drive lane, and the cruise assist of executing an automatic driving. It is acceptable to use the cruise assist which executes a partial automatic steering operation of the subject vehicle. In this case, it is acceptable for the cruise assist system 100 to have a steering angle sensor capable of acquiring a steering angle of the subject vehicle. It is also acceptable for the cruise assist system 100 to have a microcomputer system capable of controlling the steering operation of the subject vehicle, or for the target control device 41 to have a steering mechanism.
(4j) In the first exemplary embodiment previously described, the control section 30 uses the predetermined update distance of 1 km as the minimum traffic sign interval, and uses the predetermined subtraction value of +1 as the non-specific country degree of installation reliability, by which the predetermined subtraction value is subtracted from the cumulative value P at every timing when the subject vehicle moves by the predetermined update distance. However, the concept of the present invention is not limited by this.

For example, when the traffic sign shown in FIG. 2 has the non-specific country degree of installation reliability of +2, it is acceptable to use the predetermined subtraction value of +2. Further, it is acceptable for the control section 30 to use the predetermined update distance of 2 km when the minimum traffic sign interval is 2 km.

Because the cumulative value P has a positive value or a negative value, it is acceptable to use the cumulative value P which approaches zero at every timing when the subject vehicle moves by the predetermined update distance. That is, when the cumulative value P is a negative value, it is acceptable to use the predetermined subtraction value of a negative value.

(4k) In the first exemplary embodiment previously described, the area around the subject vehicle contains at least a front area of the subject vehicle. However, the concept of the present invention is not limited by this. It is acceptable for the peripheral area around the subject vehicle to contain a rear-side area and a side area of the subject vehicle. In this case, it is acceptable to mount the image sensor 10 on the upper side of the rear window to capture a rear-side image of the subject vehicle. It is also acceptable to mount the image sensor 10 on the door side mirrors capture a side image of the subject vehicle.
(4l) In the first exemplary embodiment previously described, the control section 30 uses the minimum traffic sign interval, the predetermined update distance, the predetermined subtraction value, and the non-specific country degree of installation reliability which are associated to each other. However, the concept of the present invention is not limited by this. For example, it is acceptable to use the predetermined update distance which is a value other than the minimum traffic sign interval. In this case, when one of the predetermine update distance and the predetermined subtraction value has a small value, it is preferable for the other to have a small value.
(4m) It is possible to combine the functions of the control section 30 as the device to detect the drive country according to the exemplary embodiment and modifications previously described, or to form one function by using a plurality of components. It is also possible to add at least a part of the components of the exemplary embodiment to the structure of the other exemplary embodiment, or replace at least a part of the component in the exemplary embodiment with the components of the other exemplary embodiment.
(4n) It is possible to realize the device to detect the drive country according to the present invention by using the control section 30, the cruise assist system 100, other components, and/or a non-transitory computer readable storage medium such as semiconductor memories for storing the programs to realize the functions of the present invention. The programs cause the central processing unit in the computer system to execute the functions.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A device to detect a drive country in which a subject vehicle is located, comprising:
a computer system including a central processing unit, the computer system being configured to provide:
a correspondence information acquiring section capable of acquiring correspondence information which represents a relationship between traffic signs and a degree of installation reliability of each of the traffic signs in each of countries, each of the countries being a drive country candidate in which a subject vehicle may be driving, i.e. located, and the degree of installation reliability of each of the traffic signs in each of the countries being expressed by a numeric value;
a matching information acquiring section capable of acquiring matching information which represents whether a traffic sign located around the subject vehicle matches the traffic sign stored in the correspondence information; and
a drive country estimation section capable of reading the degree of installation reliability of the traffic sign, which is indicated by the matching information, in each of the countries stored in the correspondence information, and estimating, as a drive country where the subject vehicle is driving, the country having a maximum degree of installation reliability of the traffic sign read from the correspondence information.

2. The device to detect the drive country in which the subject vehicle is located according to claim 1, wherein the matching information acquiring section repeatedly acquires the matching information, and
the drive country estimation section reads the degree of installation reliability of the traffic sign in each of the countries, which is indicated by the matching information at every timing when the matching information is acquired, calculates a cumulative value of the degree of installation reliability of the traffic sign in each of the countries, and estimates the country having a maximum cumulative value as the drive country in which the subject vehicle is driving.

3. The device to detect the drive country in which the subject vehicle is located according to claim 1, further comprising:
a drive distance information acquiring section capable of acquiring drive distance information, which represents that the subject vehicle has moved by a predetermined update distance at every timing when the subject vehicle has moved by the predetermined update distance; and
a degree of installation reliability subtracting section capable of subtracting a predetermined subtraction value from the cumulative value at every timing when the drive distance information is acquired.

4. The device to detect the drive country in which the subject vehicle is located according to claim 2, wherein the drive country estimation section estimates, as the drive country in which the subject vehicle is driving, the country having a maximum cumulative value which is not less than a predetermined country switching threshold value.

5. The device to detect the drive country in which the subject vehicle is located according to claim 3, wherein the drive country estimation section estimates, as the drive country in which the subject vehicle is driving, the country having a maximum cumulative value which is not less than a predetermined country switching threshold value.

6. The device to detect the drive country in which the subject vehicle is located according to claim 1, further comprising:
a regulation information acquiring section capable of acquiring regulation information which represents regulations of safe driving of vehicles in the drive country estimated by the drive country estimation section; and
a cruise assist section capable of executing a cruise assist of the subject vehicle within the regulations indicated by the acquired regulation information.

7. The device to detect the drive country in which the subject vehicle is located according to claim 2, further comprising:
a regulation information acquiring section capable of acquiring regulation information which represents regulations of safe driving of vehicles in the drive country estimated by the drive country estimation section; and
a cruise assist section capable of executing a cruise assist of the subject vehicle within the regulations indicated by the acquired regulation information.

8. The device to detect the drive country in which the subject vehicle is located according to claim 3, further comprising:
a regulation information acquiring section capable of acquiring regulation information which represents regulations of safe driving of vehicles in the drive country estimated by the drive country estimation section; and
a cruise assist section capable of executing a cruise assist of the subject vehicle within the regulations indicated by the acquired regulation information.

9. The device to detect the drive country in which the subject vehicle is located according to claim 4, further comprising:
a regulation information acquiring section capable of acquiring regulation information which represents regulations of safe driving of vehicles in the drive country estimated by the drive country estimation section; and
a cruise assist section capable of executing a cruise assist of the subject vehicle within the regulations indicated by the acquired regulation information.
